(19) United States
(12) Patent Application Publication
(10) Pub. No.: US 2026/0094307 A1
(43) Pub. Date: Apr. 2, 2026

(54) APPARATUS AND METHODS FOR INTEGRATED CONTENT INSIGHT AND AUTOMATED SYSTEM ACTIONS USING ARTIFICIAL INTELLIGENCE

(71) Applicant: AT&T Intellectual Property I, L.P., Atlanta, GA (US)

(72) Inventors: Mark Austin, Lucas, TX (US); Andrew Markus, Alpharetta, GA (US); Brian Nab, Allen, TX (US); Divesh Srivastava, Summit, NJ (US); Abhay Dabholkar, Allen, TX (US); Eynat Weinberg Nordman, Ramat Hasharon (IL)

(73) Assignee: AT&T Intellectual Property I, L.P., Atlanta, GA (US)

(21) Appl. No.: 18/899,043

(22) Filed: Sep. 27, 2024

(51) Int. Cl. G06T 11/00; G06T 7/00

(52) U.S. Cl. CPC G06T 11/00; G06T 7/0002; G06T 2207/30168

(57) ABSTRACT

Aspects of the subject disclosure may include, for example, obtaining textual data and non-textual data including images; interpreting, utilizing a vision understander model, content of the images resulting in interpreted content information; training an AI model based on textual data and the interpreted content information; monitoring the object (e.g., a communications network) to obtain real-time metrics associated with operation or changes to the object; analyzing the real-time metrics by applying the AI model resulting in an analysis; and generating adjustment information for adjusting the object according to the analysis. Other embodiments are disclosed.

### FIELD OF THE DISCLOSURE

The subject disclosure relates to an apparatus and methods for integrated content insight and automated system actions using artificial intelligence.

### BACKGROUND

Traditional network management systems often struggle to incorporate and interpret various forms of data such as images, diagrams, and audio. These elements can contribute to providing more comprehensive responses to queries. Existing systems focus on textual data, leading to incomplete and sometimes inaccurate responses when other data types are involved. This limitation hinders the ability to fully leverage available information for network management and decision-making.

Ensuring the accuracy and reliability of interpretations of diverse data types presents other challenges. Inaccurate interpretations can lead to incorrect responses and actions, which can negatively impact network performance. Additionally, human intervention is frequently required to correct network conditions, which can be time-consuming and prone to error. This reliance on manual processes reduces efficiency and increases operational costs.

### BRIEF DESCRIPTION OF THE DRAWINGS

Reference will now be made to the accompanying drawings, which are not necessarily drawn to scale, and wherein:

FIG. 1A is a block diagram illustrating an exemplary, non-limiting embodiment of a communications network in accordance with various aspects described herein.

FIGS. 1B and 1C are block diagrams illustrating exemplary, non-limiting embodiments of non-textual data that can be consumed by the management platform of FIG. 1A in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enhancing management of, or associated with, various objects that can include systems, processes, communications networks, financial instruments, or other items/entities. As an example, the system and methodology can enhance management by leveraging automated content analysis and Artificial Intelligence (AI) based on integrated textual and non-textual data.

One or more of the embodiments can accurately analyze and assess non-textual data (e.g., images, flowcharts, diagrams, audio, etc.) which may be contained within text (e.g., content within content) or may be stand-alone non-textual data, in order to provide comprehensive monitoring and accurate responses to queries, including queries for an image or other non-textual data. Other embodiments are described in the subject disclosure.

One or more of the embodiments can integrate and analyze both textual and non-textual data such as by developing a pipeline to extract and interpret these non-textual elements using vision understanding models/algorithms. The translated information can then be rigorously analyzed and graded, such as through a universal grading of solutions system, to ensure accuracy and reliability. This graded data can then be utilized to generate responses that can either provide insightful information or take direct action, such as correcting network conditions without human intervention, which can include leveraging the capabilities of AI agents.

One or more of the embodiments can provide comprehensive data integration. For example, the system can integrate non-textual data such as images, flowcharts, diagrams, and audio (even within text-based information), which traditional systems struggle to process effectively. One or more of the embodiments can provide vision understanding through use of vision modeling/algorithms that facilitate accurate extraction and interpretation of non-textual data, enhancing the quality of the information processed.

One or more of the embodiments can provide a universal grading system which can ensure that data interpretations are reliable and accurate, minimizing errors. One or more of the embodiments can provide automated network adjustment/correction. For example, AI agents can autonomously adjust/correct network conditions without human intervention, significantly improving response times and reducing operational down-time.

One or more of the embodiments can provide continuous improvement to the management techniques through continuous updates and human oversight, ensuring it remains current and effective in delivering high-quality insights. These features of the exemplary embodiments can collectively result in more accurate, efficient, and scalable operations, providing technical and commercial advantages over previous approaches.

One or more of the embodiments offer technical and commercial advantages over prior approaches by enhancing data integration and interpretation, automating network corrections, streamlining management, and ensuring continuous improvement, which can result in boosting efficiency, reducing costs, scaling effectively, enhancing user experiences, and accelerating innovation.

One or more aspects of the subject disclosure include a method for managing a communications network. The method can include obtaining, by a processing system including a processor, textual data and non-textual data including images; and interpreting, by the processing system utilizing a vision understander model, content of the images resulting in interpreted content information. The method can include training, by the processing system, an AI model based on textual data and the interpreted content information; and monitoring, by the processing system, the communications network to obtain real-time metrics associated with operation of the communications network. The method can include analyzing, by the processing system, the real-time metrics by applying the AI model resulting in an analysis; and generating, by the processing system, adjustment information for adjusting the communications network according to the analysis.

One or more aspects of the subject disclosure include a device, comprising: a processing system including a processor; and a memory that stores executable instructions that, when executed by the processing system, facilitate performance of operations. The operations can include monitoring an object to obtain real-time metrics associated with the object, where the monitoring comprises: obtaining a real-time image generated from parameters associated with the object; interpreting, utilizing a vision understander model, real-time content of the real-time image resulting in interpreted real-time content information; and translating the interpreted real-time content information into real-time content text that is part of the real-time metrics. The operations can include analyzing the real-time metrics by applying an AI model resulting in an analysis; and generating responsive information for the object according to the analysis.

One or more aspects of the subject disclosure include a non-transitory machine-readable medium, comprising executable instructions that, when executed by a processing system including a processor, facilitate performance of operations. The operations can include monitoring a communications network to obtain metrics, where the monitoring comprises: obtaining an image generated from parameters associated with operation of the communications network; interpreting, utilizing a vision understander model, content of the image resulting in interpreted content information; and translating the interpreted content information into content text that is part of the metrics. The operations can include analyzing the metrics by applying an AI model resulting in an analysis; and generating adjustment information for adjusting the communications network according to the analysis.

In one or more embodiments, the system and methodology can overcome problems that traditional text-based systems often struggle with in incorporation and interpretation of non-textual data. For example, a pipeline can be created to extract and interpret these non-textual elements using vision understanding algorithms to ensure that all relevant data is considered. This allows for more comprehensive and accurate responses, leveraging the full spectrum of available information.

In one or more embodiments, the system and methodology can ensure that the interpretations of non-textual data are accurate and reliable to avoid or otherwise mitigate incorrect responses and actions. For example, implementing a universal grading of solutions system enables rigorously analyzing and grading interpreted data for accuracy and reliability. This graded data ensures that responses generated are based on high-quality, accurate information.

In one or more embodiments, the system and methodology can overcome the problem that human intervention is often required to correct particular conditions of a system being monitored (e.g., a network), which can be time-consuming and prone to error. For example, by leveraging AI agents, the system and methodology can generate information (e.g., responses) that not only provide insightful information but also take direct actions to correct conditions autonomously. This improves efficiency and reduces the need for human intervention.

In one or more embodiments, the system and methodology can maintain the quality and relevance of data and insights over time, which can be challenging, particularly in fast-evolving fields like network operations and intellectual property management. Integrating human oversight and continuously updating synthetic data ensures that the system maintains high-quality, actionable insights. This continuous improvement process helps in keeping the operations efficient and innovative.

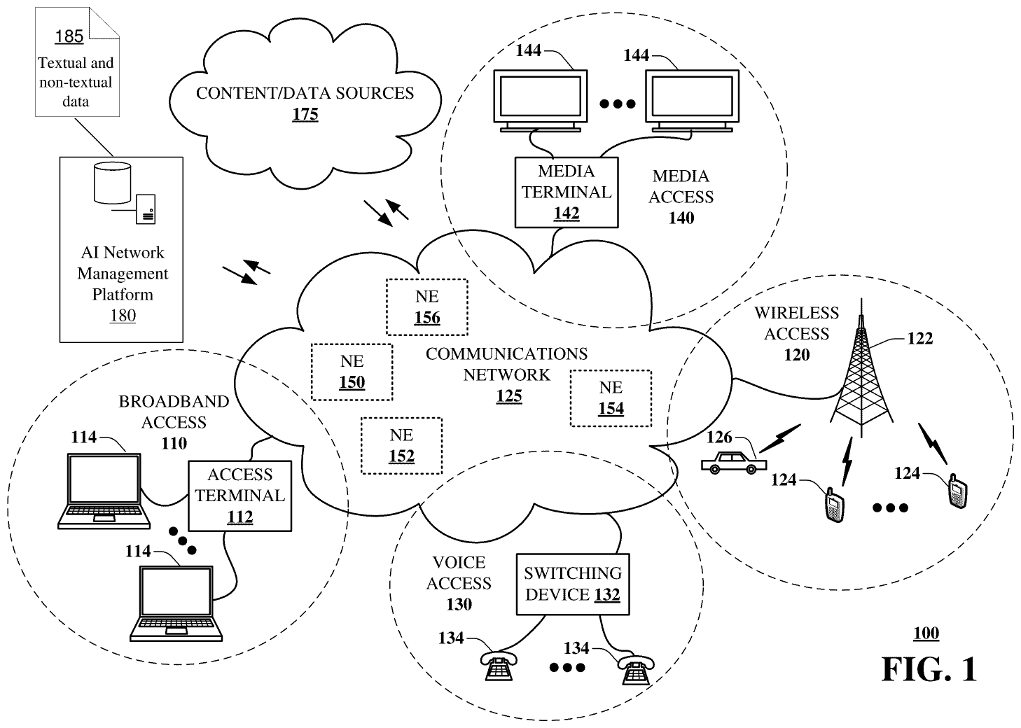

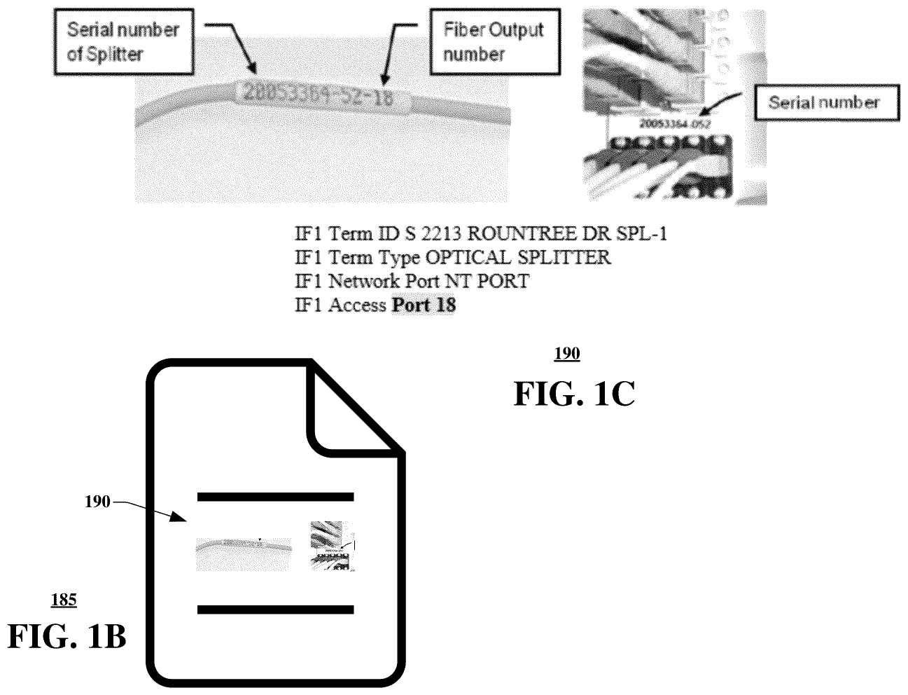

Referring now to FIG. 1A, a block diagram is shown illustrating an example, non-limiting embodiment of a system 100 in accordance with various aspects described herein. System 100 can include a management platform 180 that is configured to manage one or more systems (e.g., a communications network). The platform 180 can be an AI-based platform that utilizes one or more AI models for analysis and other functionality. The platform 180 can be centralized or distributed, and can include various hardware and software. In one or more embodiments, the platform 180 can be cloud-based utilizing virtual functionality, such as through virtual machines. In other embodiments, the platform 180 can be resident on one or more servers or other computing equipment.

Platform 180 can provide an automated content analysis pipeline to access or extract images and other non-textual elements (such as from text documents or other information 185). For instance, the pipeline can summarize and interpret the data using a vision understander or other AI model that is configured for interpreting the particular type of data (which can include audio). In one embodiment, the translated information can undergo analysis and grading through a universal grading of solutions system to ensure accuracy and reliability. This graded data can be utilized to generate responses or otherwise provide monitoring information and notifications that provide insightful information. In other embodiments, the platform 180 can be fully or partially automated, such as having the ability to take direct action to correct network conditions without human intervention.

As an example, FIGS. 1B and 1C are representative of non-textual data (in the form of images 190 of components that is included in a document or other information 185) which can be utilized in system 100 of FIG. 1A. As can be seen, information that is being utilized to train AI models, fine-tune those models and/or fed to those models for analysis can include non-textual data (e.g., images 190) that can be part of a document or other information 185 which may be text-based such as specifications for equipment that includes a written description and images or drawings of the equipment. In other embodiments, the non-textual data may be stand-alone information such as images of the equipment. In some embodiments, the non-textual data 190 can include some text that can facilitate an understanding and interpretation of the data, such as an image of a component and a wire connected with the component that includes a serial number of a splitter, a fiber output number, and the serial number of the component. For instance, the vision understander can consume the document 185 and determine various insight including connection information, a port number, and so forth.

In one or more embodiments, the platform 180 can include or make use of a vision understander for non-textual data interpretation. In one embodiment, the interpreted information can then be translated into text for further analysis, such as by another AI model. This process ensures that all relevant data, including non-textual elements, is considered for comprehensive and accurate responses, such as during training, fine-tuning and/or analysis/monitoring/managing.

In one or more embodiments, the platform 180 can include or make use of a universal grading of solutions system. For example, the grading system can establish a domain-specific baseline, such as using synthetic data graded by subject matter experts. In one or more embodiments, the grading system can employ automated and/or manual grading to ensure the quality of the translated text. In one embodiment, human-AI collaboration can be continuously refined and can improve the grading process, ensuring the accuracy and reliability of the interpreted data.

In one or more embodiments, the platform 180 can include or make use of real-time monitoring and dynamic text updates. For example, the platform 180 can continuously monitor network conditions which can be based at least in part on visual data integration, including visually understanding performance graphs, heat maps, and other non-textual data where the understanding can include interpretations and/or predictions. For instance, the system can dynamically update translated text to reflect real-time changes and anomalies in the operation of the monitored system (e.g., a communications network). This real-time monitoring ensures that the system remains current and effective in delivering high-quality insights.

In one or more embodiments, the platform 180 can include or make use of automated network condition corrections (or semi-automated such as requiring human authorization for some operations adjustments). For example, AI agent(s) can be utilized to generate responses that provide insights or take direct action to correct network conditions. For instance, the AI agent can communicate directly with the network (e.g., individual equipment and/or through the Operational Support System (OSS) or other devices of the network core) for real-time adjustments without human intervention. This automation improves efficiency and reduces the need for human intervention in network management.

In one or more embodiments, the platform 180 can provide for continuous improvement of AI models. For example, feedback from human reviewers and updated synthetic data can be utilized to enhance the grading process. For instance, the system can regularly update and train AI models to maintain accuracy and relevance. This continuous improvement process ensures that the system remains effective in delivering high-quality insights over time, particularly as operating requirements change (e.g., changes to the 3GPP standard) and/or network equipment change.

In one or more embodiments, the platform 180 can include or make use of Retrieval-Augmented Generation (RAG) which can combine strengths of retrieval-based and generation-based models to improve the quality and relevance of generated responses, particularly in natural language processing tasks such as question answering, dialogue systems, and text generation. For example, the RAG can include a retrieval component for fetching relevant information from a large corpus or database, such as through a retrieval model or a dense retrieval model, including searching the corpus for documents or passages that are most relevant to the input query or context.

As another example, the RAG can include a generation component for generating a coherent and contextually appropriate response based on the retrieved information, such as through use of a transformer-based language model. For instance, the generation model can take the retrieved documents or passages as additional context and can generate a response that is informed by this context.

In one or more embodiments, the platform 180 can apply RAG in an integrated fashion to work together including: (1) an input query or context being fed into the retrieval model, which retrieves a set of relevant documents or passages from the corpus; (2) retrieved documents or passages being fed into the generation model as additional context; and (3) the generation model using this context to generate a response that is both relevant and coherent.

In one or more embodiments, the platform 180 can apply AI to grade the accuracy of an AI model's interpretation of images. This process can involve leveraging advanced machine learning and computer vision techniques to automate the evaluation and grading of model performance. For example, the platform 180 can utilize automated confusion matrix generation. For instance, AI can automatically generate confusion matrices to evaluate classification models, such as by comparing the model's predictions with ground truth labels and calculating various performance metrics such as accuracy, precision, recall, and F1-score. As another example, the platform 180 can utilize Intersection over Union (IoU) calculation such as calculating the IoU for object detection models. For instance, this can include comparing the predicted bounding boxes with the ground truth bounding boxes and computing the overlap ratio to assess the accuracy of object detection.

As another example, the platform 180 can utilize mean Average Precision (mAP) computation. For example, AI can be used to automate the computation of mAP for object detection models by calculating the average precision for each class and then computing the mean of these average precisions to provide a comprehensive evaluation of the model's performance. As another example, the platform 180 can generate Receiver Operating Characteristic (ROC) curves and calculate the Area Under the Curve (AUC) for classification models. This can include plotting the true positive rate against the false positive rate at various threshold settings and summarizing the model's performance with a single scalar value. As another example, the platform 180 can utilize precision-recall curve generation. For instance, AI can generate precision-recall curves for models, particularly useful for imbalanced datasets, which can include plotting precision against recall at various threshold settings to evaluate the model's performance.

As another example, the platform 180 can utilize cross-validation automation. For instance, the AI can automate the process of cross-validation, partitioning the dataset into multiple subsets and training the model on different combinations of these subsets. This can assist in assessing the model's performance and robustness across different data splits. As another example, the platform 180 can utilize synthetic data grading. For instance, the AI can use synthetic datasets with known ground truth to evaluate the model's performance, which can include generating synthetic data, running the model on this data, and comparing the predictions with the known ground truth to measure accuracy.

As another example, the platform 180 can utilize benchmarking against standard datasets. For instance, the AI can automate the benchmarking process by evaluating the model's performance on standard datasets (e.g., those widely used in the particular industry or in a research community), which can provide a comparative analysis of the model's performance against other state-of-the-art models. As another example, the platform 180 can utilize error analysis automation. For instance, the AI can automate error analysis by examining the model's incorrect predictions to identify patterns and common failure modes. This can assist in understanding the limitations of the model and guiding further improvements. As another example, the platform 180 can utilize human-AI collaboration, such as the AI assisting human reviewers in grading the model's interpretations by providing initial evaluations and highlighting areas that require further review.

In one or more embodiments, the system 100 via platform 180 can facilitate in whole or in part obtaining textual data and non-textual data including images; interpreting, utilizing a vision understander model, content of the images resulting in interpreted content information; training an AI model based on textual data and the interpreted content information; monitoring the object (e.g., a communications network) to obtain real-time metrics associated with operation or changes to the object; analyzing the real-time metrics by applying the AI model resulting in an analysis; and generating adjustment information for adjusting the object according to the analysis.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media.

While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

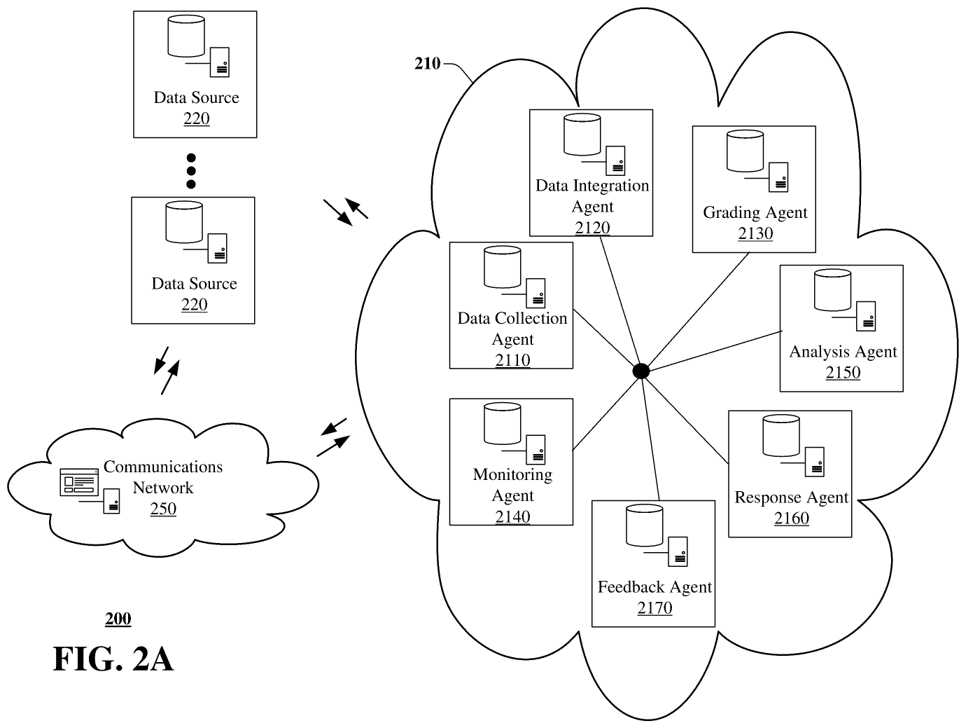

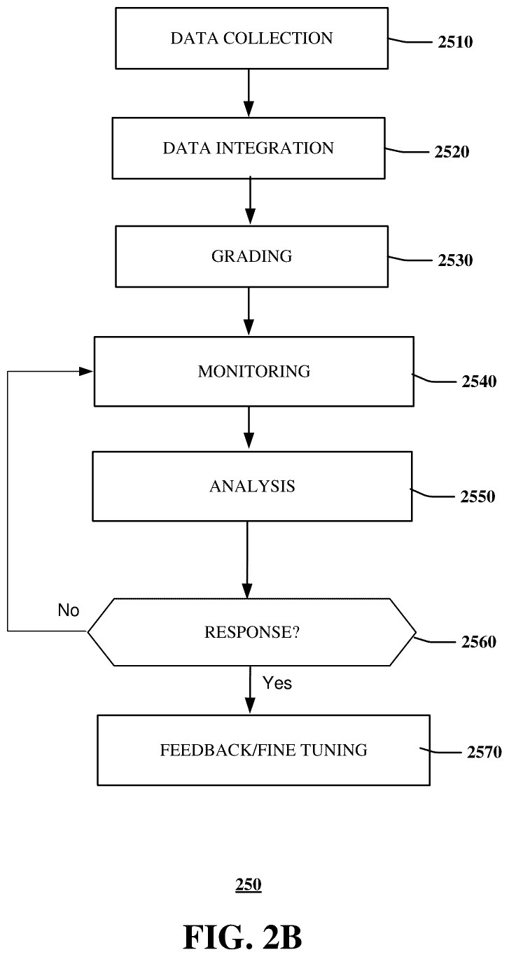

FIG. 2A is a block diagram illustrating an example, non-limiting embodiment of a system 200 functioning within or in conjunction with the communication network of FIG. 1 in accordance with various aspects described herein. In one embodiment, system 200 is configured to provide integrated content insight and automated network actions using Gen AI, which can include leveraging RAG techniques as described herein. The system 200 can include several components interconnected or otherwise interfacing to enhance network management through the integration and analysis of both textual and non-textual data.

The system 200 can include multiple data sources 220 that provide textual and/or non-textual data. These data sources 220 can be private and/or public. In one embodiment some of the data sources 220 can be associated with different entities that have agreed to share or provide access to particular data for AI model training. These data sources 220 can be connected to a communications network 250, which facilitates the transfer of data to the AI management platform 210. In one or more embodiments, one or more of the data sources 220 can be part of or otherwise associated with the network 250 such as various documents, records and data stored by a service provider operating the network 250.

In one or more embodiments, the AI management platform 210 can be composed of several agents that are each responsible for specific tasks or functionality. The agents can be of various types and configured in various ways including being provided via a cloud service or executed on one or more servers. In one or more embodiments, the agents can have access to various tools or other functionality that facilitates the agent's ability to perform its assigned tasks and assigned functionality.

In one or more embodiments, system 200 can include a data collection agent 2110. For example, agent 2210 can be responsible for extracting images and other non-textual data from various sources, including directly from text documents. It ensures that all relevant data is captured for further processing.

In one or more embodiments, system 200 can include a data integration agent 2120. This agent 2120 can utilize a vision understander to interpret the content of the images and non-textual data. The interpreted information can then be translated into text for further analysis. In the context of RAG, this agent 2120 can retrieve relevant information from the data sources to provide context for the generation component.

In one or more embodiments, system 200 can include a grading agent 2130. Agent 2130 can establish a domain-specific baseline using synthetic data graded by subject matter experts. It can implement automated and/or manual grading to ensure the quality of the translated text. The grading process ensures that the retrieved and generated information is accurate and reliable.

In one or more embodiments, system 200 can include a monitoring agent 2140. This agent 2140 can continuously monitor network conditions through visual data integration. It updates the translated text dynamically to reflect real-time changes and anomalies. The monitoring agent 2140 ensures that the system 200 remains current and effective in delivering high-quality insights.

In one or more embodiments, system 200 can include an analysis agent 2150. This agent 2150 can analyze the graded text to derive meaningful insights about network conditions. It generates alerts to notify relevant teams of potential issues. The analysis agent leverages the context provided by the retrieval component to generate accurate and relevant insights.

In one or more embodiments, system 200 can include a response agent 2160. This agent 2160 can generate responses that provide insights and/or take direct action to correct network conditions. In one embodiment, it ensures the AI agent communicates (or has the selective capability to do so) directly with the network for real-time adjustments without human intervention. The response agent 2160 uses the generated information to make informed decisions and take appropriate actions.

In one or more embodiments, system 200 can include feedback agent 2170. This agent 2170 can use feedback from human reviewers and can update synthetic data to enhance the grading process. It regularly updates and trains the AI model(s) to maintain accuracy and relevance. The feedback agent 2170 ensures continuous improvement of the system 200 by incorporating new data and insights.

The interconnected agents within the AI management platform 210 can work collaboratively to ensure comprehensive data integration, accurate interpretation, and effective network management. The system 200 leverages AI capabilities, including RAG techniques, to automate network actions, improve efficiency, and reduce the need for human intervention. In one embodiment, one or more of the AI agents can be used for training models, fine-tuning models and/or applying AI model(s) for analyzing real-time data, such as for operational adjustments to the communications network.

One or more of the agents of AI platform 210 (e.g., data collection agent 2110, monitoring agent 2140, analysis agent 2150, etc.) can include a vision understander which can include AI that specializes in, or provides functions for, interpreting and understanding visual data, such as charts, drawings, graphs, images, videos and so forth. As an example, the vision understander can leverage advanced computer vision and machine learning techniques to analyze visual content and extract meaningful information, which can be used for training models, fine-tuning models and/or applying AI model(s) for analyzing real-time data.

In one or more embodiments, the vision understander can include or make use of a Convolutional Neural Network (CNN) which is a deep neural network specifically designed for processing structured grid data, such as images. CNNs are highly effective in tasks like image classification, object detection, and segmentation due to their ability to automatically and adaptively learn spatial hierarchies of features from input images. In one embodiment, the vision understander can perform transfer learning using pre-trained models on large datasets and fine-tuning them on specific tasks. In other embodiments, the vision understander and/or AI can be part of, make use of, or can include multi-modal LLMs such as GPT4V, Pixtral, and so forth.

In one embodiment, the vision understander can include or make use of Generative Adversarial Networks (GANs) which are two neural networks, a generator and a discriminator, that compete against each other. They are used for generating high-quality synthetic images and can be employed for tasks like image-to-image translation, super-resolution, and data augmentation.

In one embodiment, the vision understander can include or make use of Recurrent Neural Networks (RNNs) and Long Short-Term Memory (LSTM) networks which can be used for sequence prediction tasks and can be applied to image captioning, where the model generates descriptive text for a given image. These networks can facilitate in understanding the temporal dependencies in image sequences.

In one embodiment, the vision understander can include or make use of attention mechanisms which allow models to focus on specific parts of an image while making predictions. This technique is particularly useful in tasks like image captioning, object detection, and image segmentation, where understanding the context and relationships between different parts of the image is crucial.

In one embodiment, the vision understander can perform semantic segmentation by classifying each pixel in an image into a predefined category. As an example, Fully Convolutional Networks (FCNs) can be used for this purpose, enabling detailed understanding of the image content.

In one embodiment, the vision understander can perform object detection to identify and locate objects within an image. In one embodiment, the vision understander can perform image augmentation which involves creating variations of the original images through transformations like rotation, scaling, flipping, and/or cropping. This can assist in increasing the diversity of the training dataset and improving the robustness of the model.

In one embodiment, the vision understander can perform feature extraction by identifying and extracting relevant features from images for further analysis. For example, Scale-Invariant Feature Transform (SIFT) and Histogram of Oriented Gradients (HOG) can be employed to capture important details in images.

In one embodiment, the vision understander can perform image embeddings which can include representing images as high-dimensional vectors in a continuous vector space, and which can facilitate capturing semantic relationships between different images. In one embodiment, any number of these components and techniques can be combined and customized based on the specific requirements of the vision understander, ensuring accurate and reliable analysis of visual data.

In one or more embodiments, the platform 210 (e.g., grading agent 2130) can employ various grading techniques (e.g., human/and/or AI implemented) including one, some or all of confusion matrices, IoU metrics, mAP metrics, ROC Curves, AUC metrics, precision-recall curves, cross-validation, human evaluation, synthetic data grading (e.g., using synthetic datasets with known ground truth to evaluate the model's performance including controlled experiments and precise measurement of the model's accuracy), benchmarking against standard datasets, and error analysis.

In one or more embodiments, the platform 210 (e.g., feedback agent 2130) can employ various training, feedback and/or fine-tuning techniques (e.g., human/and/or AI implemented) such as by adjusting a pre-trained model to better suit a specific task or dataset. Various techniques (or combinations thereof) can be employed for fine-tuning an AI model(s). As an example, platform 210 can utilize transfer learning such as using a pre-trained model on a large dataset and fine-tuning it on a smaller, task-specific dataset. As an example, platform 210 can utilize learning rate scheduling such as adjusting the learning rate during training to facilitate in fine-tuning the model, such as by step decay, exponential decay, and cyclical learning rates which can optimize or improve the learning rate, ensuring that the model converges effectively. As an example, platform 210 can utilize data augmentation by creating variations of the original dataset through transformations like rotation, scaling, flipping, and cropping. This can assist in increasing the diversity of the training dataset and improving the robustness of the model. As an example, platform 210 can utilize regularization, such as L1 and L2 regularization, dropout, and batch normalization which can be used to prevent overfitting and improve the generalization of the model. These techniques can add constraints to the model parameters, ensuring that the model does not become too complex.

Continuing with various fine-tuning techniques that can be implemented by platform 210, as an example, the platform can utilize freezing layers such as by freezing the initial layers of a pre-trained model and only fine-tuning the later layers to assist in retaining the learned features from the pre-trained model while adapting it to the new task. As an example, platform 210 can utilize hyperparameter tuning. This can include optimizing hyperparameters such as learning rate, batch size, and the number of epochs to improve the performance of the model. For instance, grid search, random search, and/or Bayesian optimization can be used for hyperparameter tuning. As an example, platform 210 can utilize fine-tuning of specific layers which can include (instead of fine-tuning the entire model), fine-tuning specific layers or blocks of layers which allows for more targeted adjustments. As an example, platform 210 can utilize gradient clipping by setting a threshold for the gradients during back-propagation to prevent exploding gradients. This technique can assist in stabilizing the training process and ensuring that the model converges effectively. As an example, platform 210 can utilize early stopping by monitoring the model's performance on a validation set and stopping the training process when the performance starts to degrade. This technique can assist in preventing overfitting and ensuring that the model generalizes well to new data. As an example, platform 210 can utilize ensemble learning techniques such as bagging, boosting, and stacking to combine multiple models and improve the overall performance. Fine-tuning individual models in the ensemble can lead to better generalization and robustness. In one or more embodiments, some or all of these techniques can be combined and customized based on the specific requirements of the fine-tuning task.

In one or more embodiments, AI platform 210 can generate synthesized data to provide a robust dataset for training. In other embodiments, the synthesized data can include data representing inputs that lead to undesired or worst-case scenarios for the performance of a system. In other embodiments, the synthesized data can represent inputs that lead to other scenarios (e.g., positive or negative circumstances) for the performance of a system. In one embodiment, this can be done through the use of AI (with or without human intervention) by leveraging advanced machine learning and data generation techniques to create synthetic datasets that simulate extreme conditions or edge cases. As an example, GANs (i.e., a generator and a discriminator) can compete against each other to generate high-quality synthetic data that represents undesired or worst-case scenarios by training the generator to produce data that the discriminator finds challenging to distinguish from real data. This approach can be used to create extreme conditions or edge cases that stress the system's performance. In one or more embodiments, the LLM can generate synthetic sentences or synthetic data, which can be utilized as described herein including for training, fine-tuning, testing, etc.

In one or more embodiments, synthesized data can be generated from adversarial examples which are inputs specifically designed to cause a model to make incorrect predictions. For example, AI can be used to generate adversarial examples that represent undesired or worst-case scenarios by perturbing the input data in a way that maximizes the model's prediction error. This technique is particularly useful for testing the robustness and security of AI models.

In one or more embodiments, synthesized data can be generated via reinforcement learning by training an agent to make decisions through rewarding it for actions that lead to desired outcomes. For instance, AI can use reinforcement learning to generate synthetic data that represents undesired or worst-case scenarios by training the agent to explore and identify inputs that cause the system to perform poorly. This approach can be used to simulate extreme conditions and identify potential vulnerabilities in the system.

In one or more embodiments, synthesized data can be generated via a Monte Carlo simulation which involves generating a large number of random samples to model the probability distribution of different outcomes. AI can use Monte Carlo simulation to generate synthetic data that represents undesired or worst-case scenarios by sampling from the extreme tails of the distribution. This technique can be used to simulate rare events and stress-test the system's performance under extreme conditions.

In one or more embodiments, synthesized data can be generated via data augmentation, which involves creating variations of the original dataset through transformations like rotation, scaling, flipping, and cropping. AI can use data augmentation to generate synthetic data that represents undesired or worst-case scenarios by applying extreme transformations that stress the system's performance. This approach can be used to test the system's robustness and generalization capabilities.

In one or more embodiments, synthesized data can be generated via scenario-based testing. This can include specific test cases being created that simulate undesired or worst-case scenarios. AI can be used to generate synthetic data for scenario-based testing by identifying and modeling the conditions that lead to poor system performance. This approach can be used to systematically explore the system's behavior under different extreme conditions.

In one or more embodiments, synthesized data can be generated via Bayesian optimization. This can include using probabilistic models to optimize a function by exploring the input space. AI can use Bayesian optimization to generate synthetic data that represents undesired or worst-case scenarios by identifying inputs that maximize the system's performance degradation. This technique can be used to efficiently explore the input space and identify potential vulnerabilities.

In one or more embodiments, AI platform 210 can implement control mechanisms with respect to automation of operational management. As an example, platform 210 can provide Human-in-the-Loop (HITL) in which human oversight is incorporated into the decision-making process, such as human operator review to approve critical decisions made by the AI. In one or more embodiments, AI platform 210 can utilize redundant systems and fail-safes including redundant sensors, control systems, and communication channels. In one or more embodiments, AI platform 210 can define safety constraints and boundaries within which the AI must operate. For instance, these constraints can be hard-coded rules or dynamically adjusted based on real-time data. In one or more embodiments, AI platform 210 can implement anomaly detection algorithms to identify unusual conditions in real-time. In one or more embodiments, AI platform 210 can provide simulation and testing of the AI system under various scenarios, including edge cases and worst-case conditions, to identify potential undesired issues before deployment. This process can ensure that the AI system can handle unexpected situations safely. In one or more embodiments, AI platform 210 can provide explainability and transparency to ensure that the AI system's decision-making process is explainable and transparent which allows human operators to understand why certain actions are taken. This can assist in diagnosing issues and making informed decisions about interventions.

In one or more embodiments, AI platform 210 can apply rate limiting and throttling controls to prevent (e.g., in some instances) the AI system from making rapid, successive changes that could destabilize a system.

FIG. 2B depicts an illustrative embodiment of a method 250 in accordance with various aspects described herein. Method 250 can be utilized for enhancing operational management (e.g., of a communications network) through integrated content insight and automated network actions. As an example, the method 250 can be implemented by the system 200 as illustrated by FIG. 2A or the system 100 as illustrated by FIG. 1A.

At 2510, the method 250 can include data collection. For example, extracting images and other non-textual data (e.g., from text documents) can be performed to ensure that all relevant data is captured for further processing. At 2520, the method 250 can include data integration. For example, a vision understander can be utilized to interpret the content of the images and non-textual data. In one embodiment, the interpreted information can then be translated into text for further analysis, such as by another AI model that is trained for operational analysis/performance improvement.

At 2530, the method 250 can include grading. For example, a domain-specific baseline(s) can be established or otherwise generated. For instance, the baseline(s) can be based in whole or in part of synthetic data graded by subject matter experts (e.g., humans and/or AI expert models). In one embodiment, the method 250 can implement automated and manual grading to ensure the quality of the translated text. In another embodiment, the grading can be used as part of the training including adjusting parameters of the model, weighting of the accuracy of particular data, and so forth. In one or more embodiments, the steps described above can be utilized for training AI models, fine-tuning AI models and/or applying AI models (e.g., as a pre-processing step applied to information utilized for input to an AI model).

At 2540, the method 250 can include monitoring. For example, method 250 can continuously monitor network conditions, which can be based at least in part on visual data integration (e.g., images such as performance graphs, heat maps, etc.). The method 250 can update the translated text dynamically to reflect real-time changes and anomalies.

At 2550, the method 250 can include analysis. In one embodiment, graded text or other integrated data (e.g., text-based and non-text-based data) can be analyzed by an AI model to derive meaningful insights about network conditions. In another embodiment, notifications and/or alerts can be generated to notify relevant teams of potential issues.

At 2560, the method 250 can include determining whether a response is required. If a response is required, the method proceeds to 2570. If no response is required, the method returns to step 2540 for continued monitoring. At 2570, the method 250 can include feedback and fine-tuning. For example, feedback such as from human reviewers or AI model reviewers can be employed, as well as updating of synthetic data, to enhance various functions of the AI platform including data collection, non-textual data analysis, grading and so forth. In one or more embodiments, the method 250 can regularly update and train AI models (e.g., which can be employed by one or more of the agents illustrated in system 200 of FIG. 2A) to maintain accuracy and relevance.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, the system and methodology can manage various systems (e.g., a communications network, investment platform, manufacturing facility, healthcare system, IP management system, etc.) directly and/or indirectly such as requiring human interaction for certain actions proposed by the AI platform and not requiring human interactions for other actions implemented by the AI platform. This process can include dynamically adjusting which actions are automatic and which actions are subject to human authorization based on a number of factors and/or in a number of ways/techniques, including based on risk assessments, historical actions/consequences, predicted consequences of actions, etc. and/or utilizing the AI platform (e.g., one or more AI/ML models) for making the adjustments.

In one or more embodiments, the system and methodology can be applied to datasets that include any number of, or percentage of, non-textual data, including datasets composed of 40% or more of images where particular pertinent information associated with the datasets may only be contained in some or all of the images. As an example, images of hardware components (e.g., fiber optic lines or couplers) may include parameters associated with the hardware components that are in the images (e.g., a parameter printed on the outer sheath) and which is not included in any text accompanying the images. In one or more embodiments, the system and methodology enables discerning or determining information from an AI-based analysis of images in instances where the information may not otherwise be available in text data.

In one or more embodiments, the system and methodology can utilize its AI model(s) that are trained and fine-tuned based on textual data and non-textual data to improve accuracy in analysis of information and systems and/or in providing responses to queries, as compared to systems that are text-only AI models.

In one or more embodiments, the system and methodology can collect data from various sources (e.g., public and/or private), including information, data and documentation from the entity operating the system to be managed (e.g., a communication service provider for a communications network) such as policies, procedures, best-practices, manuals (e.g., hardware and software), logs, performance data, marketing material, historical service records, customer records, images, flowcharts, diagrams, audio, etc. In one or more embodiments, the type of data collected or otherwise accessed by the system and methodology can vary and can be textual data and non-textual data. In one or more embodiments, the data may not be limited to any particular type or format unless the AI platform chooses to implement such a limitation as to type or format.

In one or more embodiments, the system and methodology can employ various techniques for AI/ML modeling and analysis, including Large Language Modeling, Retrieval Augmented Generation Modeling, Deep Learning, Convolution Neural Networks, and so forth.

In one or more embodiments, the system and methodology can apply a vision understander or other AI-based image analyzer (e.g., operating as a multimodal LLM) to describe, discern and/or summarize non-textual/vision-based data (which can include images, drawings, flow-charts, heat maps, graphs, etc.). As an example, the vision understander can analyze an image (which may be a stand-alone document or may be embedded in another document including text-based documents) to describe any information as to what is being shown in the image, which not only includes the different objects in the images but characteristics of the objects (e.g., colors in a heat map, slope of a line in a performance graph, dimensions, etc.) and/or the relationship between the objects (e.g., darker shades at particular coordinates of a heat map, intersection point of lines in a performance graph, etc.).

In one or more embodiments, the system and methodology can apply different types of vision understanders or other AI-based image analyzers depending on the type of non-textual data that is being analyzed.

In one or more embodiments, the system and methodology can adjust the non-textual data into other formats or forms to facilitate analysis by the AI model and/or to determine other characteristics of the data, such as transformations that enhance the interpretability and highlight important features, making it easier for the AI to extract meaningful information. As an example: normalization can scale to a specific range; color mapping can assign specific colors to different value ranges such as in a heat map; thresholding can set a specific value threshold and convert all values above or below this threshold to a binary representation; smoothing techniques, such as Gaussian blur or median filtering, can reduce noise and enhance continuity; contour mapping can draw contour lines to represent regions with similar values; gradient mapping can highlight the rate of change in values; logarithmic scaling can apply a logarithmic transformation to values; histogram equalization can enhance contrast by redistributing intensity values; edge detection techniques, such as the Sobel or Canny edge detector, can identify the boundaries of regions with significant value changes; and/or Region Of Interest (ROI) extraction can identify and isolate specific regions of interest. One or more of these techniques can be selectively applied (e.g., according to types of images/non-textual data), including across large sets of non-textual data (e.g., a large volume of heat maps representative of network traffic at different time periods under different conditions), to facilitate analysis and provide efficiency (e.g., lower compute time and resources required) in the analysis.

In one or more embodiments, the non-textual data can be audio such as recorded messages of customers or technicians, presentations provided by engineers describing the system, detected sounds from hardware in operation, and so forth. In one or more embodiments, the non-textual data can be mapping representative of traffic flows, congested areas, and/or non-congested areas. In one or more embodiments, the non-textual data can be mapping or images of triggered alarms.

In one or more embodiments, the system and methodology can more efficiently and/or accurately make predictions for some types of data according to mappings of large datasets (e.g., a heat map of network traffic) as compared to an analysis of the dataset directly.

In one or more embodiments, the system and methodology can provide time-based determinations and predictions, such as providing a performance analysis for a current time and also for a future time. In other embodiments, the predictions can include estimating when the performance characteristic(s) will pass a particular threshold (e.g., a threshold at which time a certain action should be taken). As an example, the predictions can include providing information as to different actions that would be required at different times, such as predicting that a first set of equipment will need to be made operational at time T1 to maintain a particular QoS KPI and further predicting that if the first set of equipment is not made operational at time T1 then the first set of equipment and a second set of equipment will need to be made operational at time T2 to bring performance back up to the particular QoS KPI.

In one or more embodiments, the system and methodology can provide alerts or notifications whether or not the particular analysis was queried, such as: providing an analysis of network traffic and information as to equipment usage; and additionally providing a notification indicating that as a result of the analysis determining that equipment X usage is predicted to increase by amount Y, it is further determined/predicted that equipment X will require maintenance at time T3.

In one or more embodiments, the system and methodology can generate or obtain synthetic data which can be utilized to establish baseline models, test particular scenarios or otherwise be utilized by the AI platform (which can include performing an analysis on the synthetic data with or without being combined with actual system data) to provide predictions and other information regarding a system. For example, synthetic data can be generated that is representative of network traffic when particular undesired conditions exist, such as a hurricane striking a service area. In some scenarios, actual data may not exist if the scenario has never happened (or the relevant data has never been collected). Synthetic data can be generated to predict data that would result from the scenario, such as predicting network traffic through particular devices when other equipment has been taken offline due to the hurricane. The synthetic data can be generated or obtained in various ways by various techniques including extrapolation from actual data, AI modeling of predicted synthetic data based on some assumed conditions of the scenario (e.g., assuming that equipment X, Y and Z will not be available), or other methodologies that may or may not involve use of AI modeling.

In one or more embodiments, the system and methodology can utilize subject matter experts to produce particular questions and/or verified answers which can be used to create synthetic data. In other embodiments, an AI model can then be applied to this synthetic data to generate additional synthetic data, such as for different scenarios.

In one or more embodiments, the synthetic data can be synthetic non-textual data which is fed into the AI model to determine the accuracy of information determined from the synthetic data, such as generating heat maps of synthetic data representative of network traffic. The AI model can then be fed the synthetic heat maps to see what predictions or information the AI model is capable of determining from the synthetic heat maps. In one or more embodiments, this can be utilized in an iterative fashion, such as for training and/or fine-tuning of the vision understander. As an example, synthetic images for training and/or fine-tuning can be used where humans provide question-answer pairs for training of the vision understander and improving its accuracy. In one or more embodiments, the utilization of question-answer pairs for training of the vision understander and improving its accuracy, can be according to a grading system as described herein which can be done for synthetic images and/or actual images.

In one or more embodiments, AI modeling (e.g., a large language model) can be employed to perform grading (with or without human assistance) including for the training and/or fine-tuning of the vision understander. In one or more embodiments, the grading can be based on a scale (e.g., one to ten) according to how well a generated answer matches a truth setting. As an example, grading can be based on various factors or metrics including readability, completeness, etc.

In one or more embodiments, the AI platform can fine-tune its grading process and/or any AI model utilized for grading, which can be done at different times or at the same time as fine-tuning of the visual understander or other AI model being employed for analyzing the textual and/or non-textual data.

In one or more embodiments, the system and methodology can perform real-time monitoring associated with the system being managed (e.g., a communication network). For example, there can be various KPIs that are routinely assessed and any AI-generated descriptions associated with those KPIs can be updated according to the real-time monitoring. In other embodiments, the real-time monitoring can be utilized as an input in conjunction with particular queries that are generated by personnel.

In one or more embodiments, the system and methodology can employ K-means clustering techniques. For example, K-means clustering can be used to segment extracted non-textual data (e.g., images, diagrams) into meaningful clusters. This segmentation can assist in identifying patterns and anomalies within the data, which can facilitate accurate interpretation and analysis. In one embodiment, by clustering similar features together, K-means can facilitate reducing the dimensionality of the data, making it easier for a vision understander to process and interpret the information. As another example, K-means clustering can be used to detect anomalies in network conditions by identifying data points that do not fit well into any cluster. These anomalies can be flagged for further investigation, assisting in real-time monitoring and alert generation. Clustering network performance metrics can also assist in identifying different operating conditions and optimizing the network management strategies accordingly. This can lead to more effective automated network actions and improved overall performance. By clustering feedback data from human reviewers and synthetic data, K-means can help in identifying areas where the AI models need improvement. This can guide the continuous refinement and training of the AI models, ensuring they remain accurate and relevant. In one or more embodiments, other types of clustering (e.g., alone, in combination with each other, and/or in combination with K means) can also be utilized including hierarchical clustering, mean shift clustering, Gaussian Mixture Models (GMM), spectral clustering, and/or agglomerative clustering.

In one or more embodiments, the system and methodology can provide an image/data translation capability. For example, words can be extracted from speech or dialogue associated with monitoring conditions, translated into data, and charts/graphical representations can be derived therefrom. In one embodiment, a display can be presenting real-time conditions which are changing over time (e.g., network congestion, traffic, resource usage, etc.), and a graphical representation can be generated describing the changes that occurred (e.g., a visual understander can be applied to each display at particular intervals deriving a description of what is being shown by each display, and then a graphical representation or other visual description of the changes can be generated or derived from the generated data).

In one or more embodiments, the system and methodology can identify related data/conditions/hardware/software and provide descriptions of that related data/conditions/hardware/software when monitoring for a particular condition(s). For example, monitoring of network traffic can result in an alert or detection associated with traffic over a threshold at a particular node, and can further result in other information being provided/discerned/predicted, such as traffic, resource usage, metrics, etc., for associated nodes, such as upstream, downstream, and/or alternative path nodes. In one or more embodiments, the system and methodology can utilize network topology as a guide for monitoring (e.g., investigating similar potential faults at various related locations), including adjusting monitoring for connected nodes (e.g., frequency, metrics measured, etc.) when a first node(s) triggers an alarm or is outside of a desired threshold.

In one or more embodiments, the system and methodology can analyze the data in real-time to determine locations of faults, such as monitoring traffic flows, resource usage, customer complaints, etc. to identify a potential fiber cut at a particular location. In one embodiment, the AI platform can generate a ticket to dispatch a technician based on this determination, where the ticket generation can be done with or without human intervention.

In one or more embodiments, the system and methodology can utilize various agents, which can have access to various tools including AI modeling and other tools that can be tasked with functions and in some embodiments that can operate independently, for performing data collection, data Integration, grading, monitoring, analysis, response/notifications, and feedback. In one or more embodiments, one or more of the agents can utilize different AI models for performing their particular tasks, such as a first AI model for monitoring real-time data, a second AI model for analyzing textual data, a third AI model for analyzing non-textual data, and so forth.

In one or more embodiments, the system and methodology described herein represents an improvement over previous approaches by enhancing the integration and interpretation of non-textual data, automating response generation and network corrections, streamlining the patent application process, and ensuring continuous improvement. These innovations result in more accurate, efficient, and scalable operations, providing significant technical and commercial advantages.

For instance, images depicting network conditions such as bottlenecks, latency issues, traffic patterns, or topological structures can be translated into textual data that reveal specific network inefficiencies or potential disruptions. Further analysis of this translated text can suggest actionable insights, such as rerouting traffic to alleviate congestion, upgrading infrastructure to reduce latency, or identifying and rectifying faulty wiring connections.

In one or more embodiments, the system and methodology described herein can analyze data that may only exist in visual formats, such as visualizations on screens, equipment status lights, or pictures of wiring setups. These images may need to be converted into text and accompanied by policy insights that define what constitutes particular conditions such as “good” or “bad” conditions. This can further enable the language model to understand the context and provide informed recommendations, ultimately enhancing network performance and reliability.

In one or more embodiments, the system and methodology described herein can create a pipeline to extract these images or non-textual elements from text documents, followed by summarizing and interpreting them using a vision understander. The translated information can then be analyzed and graded to ensure accuracy and reliability. This graded data can then be utilized to generate responses that can either provide insightful information or take direct action to correct network conditions without human intervention, leveraging the capabilities of AI agents.

In one or more embodiments, the system and methodology described herein can be applied in various industries such as: healthcare (e.g., medical imaging to improve diagnostics by accurately interpreting X-rays, MRIs, CT scans, etc.; and managing patient records to enhance record management by integrating non-textual data); financial institutions (e.g., fraud detection to detect fraud through analysis of transaction images and recorded conversations; and document processing which can speed up and improve the accuracy of processing financial documents); manufacturing (e.g., quality control to inspect products for defects using image analysis; and process automation to optimize production workflows and maintenance schedules); retail/e-commerce (e.g., inventory management to automate stock image analysis for accurate inventory management; and customer service which can improve AI-driven customer service by interpreting images of faulty products); education and research (e.g., research data analysis can include analyzing complex datasets with non-textual elements; and educational tools can enhance learning with integrated visual aids); and media/entertainment (e.g., content management can include automated categorization and analysis of visual and audio content; and interactive experiences can enhance user experiences with integrated non-textual data).

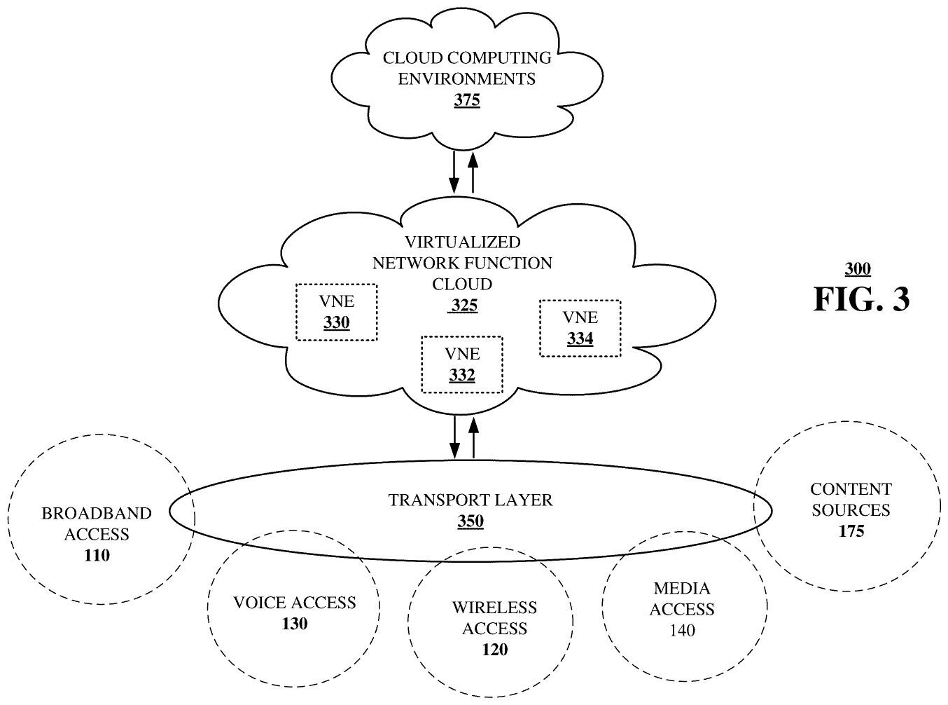

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1A, 2A, 2B, and 3.

For example, virtualized communication network 300 can facilitate in whole or in part obtaining textual data and non-textual data including images; interpreting, utilizing a vision understander model, content of the images resulting in interpreted content information; training an AI model based on textual data and the interpreted content information; monitoring the object (e.g., a communications network) to obtain real-time metrics associated with operation or changes to the object; analyzing the real-time metrics by applying the AI model resulting in an analysis; and generating adjustment information for adjusting the object according to the analysis.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

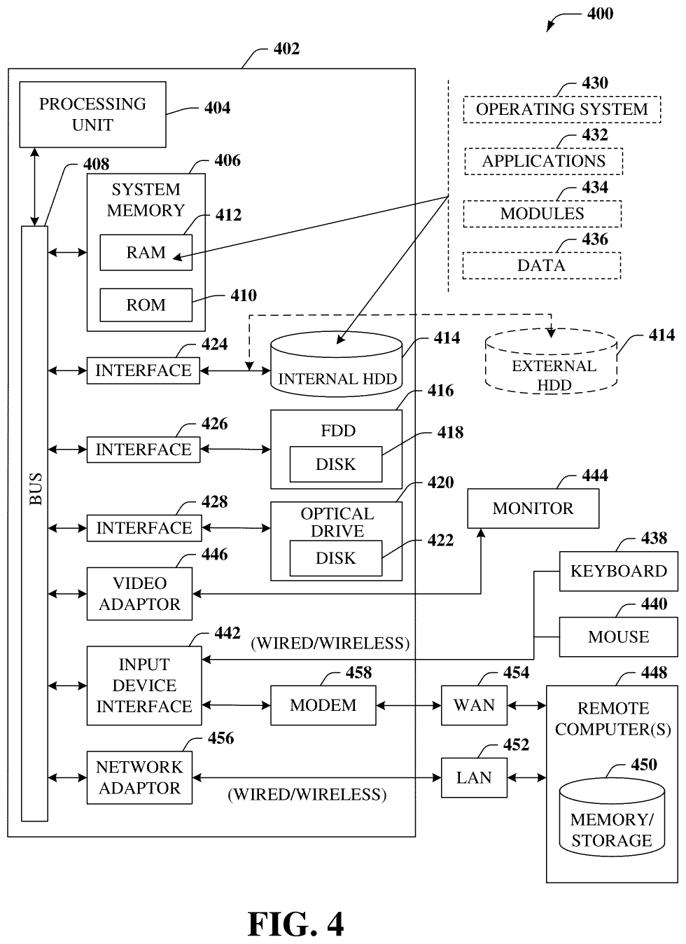

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software.

For example, computing environment 400 can facilitate in whole or in part obtaining textual data and non-textual data including images; interpreting, utilizing a vision understander model, content of the images resulting in interpreted content information; training an AI model based on textual data and the interpreted content information; monitoring the object (e.g., a communications network) to obtain real-time metrics associated with operation or changes to the object; analyzing the real-time metrics by applying the AI model resulting in an analysis; and generating adjustment information for adjusting the object according to the analysis.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures.

The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

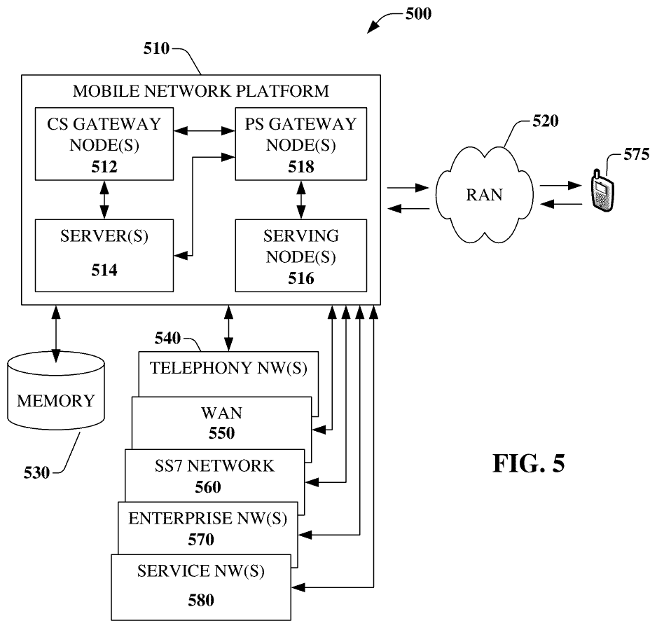

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part obtaining textual data and non-textual data including images; interpreting, utilizing a vision understander model, content of the images resulting in interpreted content information; training an AI model based on textual data and the interpreted content information; monitoring the object (e.g., a communications network) to obtain real-time metrics associated with operation or changes to the object; analyzing the real-time metrics by applying the AI model resulting in an analysis; and generating adjustment information for adjusting the object according to the analysis. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

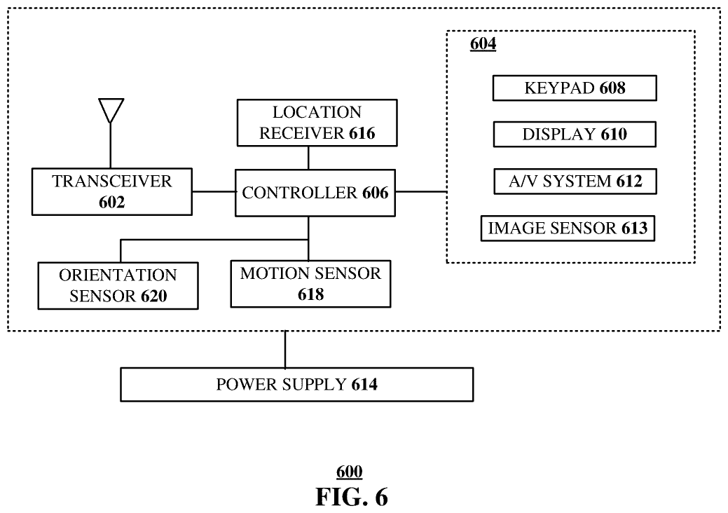

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125.

For example, computing device 600 can facilitate in whole or in part obtaining textual data and non-textual data including images; interpreting, utilizing a vision understander model, content of the images resulting in interpreted content information; training an AI model based on textual data and the interpreted content information; monitoring the object (e.g., a communications network) to obtain real-time metrics associated with operation or changes to the object; analyzing the real-time metrics by applying the AI model resulting in an analysis; and generating adjustment information for adjusting the object according to the analysis.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method for managing a communications network, the method comprising:
obtaining, by a processing system including a processor, textual data and non-textual data including images;
interpreting, by the processing system utilizing a vision understander model, content of the images resulting in interpreted content information;
training, by the processing system, an Artificial Intelligence (AI) model based on textual data and the interpreted content information;
monitoring, by the processing system, the communications network to obtain real-time metrics associated with operation of the communications network;
analyzing, by the processing system, the real-time metrics by applying the AI model resulting in an analysis; and
generating, by the processing system, adjustment information for adjusting the communications network according to the analysis.

2. The method of claim 1, wherein at least a portion of the non-textual data and at least a portion of the images are contained together within one or more documents, wherein the obtaining the non-textual data comprises extracting one or more of the images from the one or more documents, and wherein the training the AI model comprises:
translating the interpreted content information into content text; and
applying a grading process to the content text to evaluate a quality of the content text,
wherein the training of the AI model is based in part on the content text and the quality of the content text.

3. The method of claim 1, wherein the training the AI model comprises:
generating synthetic data associated with the operation of the communications network, wherein the training of the AI model is based in part on the synthetic data.

4. The method of claim 3, wherein at least a portion of the synthetic data is generated by the AI model.

5. The method of claim 2, wherein the grading process includes applying a grading AI model that is at least partially trained according to human input and according to synthetic data.

6. The method of claim 1, wherein the adjustment information includes commands that are implemented at equipment of the communications network without human intervention.

7. The method of claim 1, wherein the adjustment information includes a notification provided to one or more computing devices, and wherein the notification includes a description of a network condition determined by the analysis and a mitigation action.

8. The method of claim 1, wherein the adjustment information includes a prediction of a network condition determined by the analysis and includes a future time predicted for the network condition.

9. The method of claim 1, further comprising:
receiving, by the processing system, a query corresponding to the operation of the communications network; and
generating, by the processing system, a response to the query utilizing the AI model.

10. The method of claim 9, wherein the query corresponding to the operation of the communications network is based on a real-time image that is generated from parameters associated with the operation of the communications network, and wherein the generating the response to the query comprises:
interpreting, by the processing system utilizing the vision understander model, real-time content of the real-time image resulting in interpreted real-time content information; and
translating the interpreted real-time content information into real-time content text that is provided to the AI model.

11. The method of claim 9, further comprising:
applying, by the processing system, a grading process to the query and the response to generate a quality of the response; and
fine tuning, by the processing system, the AI model according to the query, the response and the quality of the response.

12. The method of claim 1, wherein the monitoring of the communications network to obtain the real-time metrics comprises:
obtaining real-time images that are generated from parameters associated with the operation of the communications network;
interpreting, by the processing system utilizing the vision understander model, real-time content of the real-time images resulting in interpreted real-time content information; and
translating the interpreted real-time content information into real-time content text.

13. The method of claim 12, wherein the monitoring of the communications network to obtain the real-time metrics further comprises applying a grading process to the real-time content text to evaluate a quality of the real-time content text.

14. A device, comprising:
a processing system including a processor; and
a memory that stores executable instructions that, when executed by the processing system, facilitate performance of operations, the operations comprising:
monitoring an object to obtain real-time metrics associated with the object, wherein the monitoring comprises:
obtaining a real-time image generated from parameters associated with the object;
interpreting, utilizing a vision understander model, real-time content of the real-time image resulting in interpreted real-time content information; and
translating the interpreted real-time content information into real-time content text that is part of the real-time metrics;
analyzing the real-time metrics by applying an Artificial Intelligence (AI) model resulting in an analysis; and
generating responsive information for the object according to the analysis.

15. The device of claim 14, wherein the object is one of a communications network, a system, a process, or a financial instrument.

16. The device of claim 14, wherein the responsive information includes a prediction of a condition associated with the object determined by the analysis and includes a future time predicted for the condition.

17. The device of claim 14, wherein the AI model is trained by:
interpreting, utilizing the vision understander model, content of images resulting in interpreted content information; and
training the AI model based on textual data and the interpreted content information.

18. The device of claim 17, wherein the AI model is trained by:
translating the interpreted content information into content text; and
applying a grading process to the content text to evaluate a quality of the content text,
wherein the training of the AI model is based in part on the content text and the quality of the content text.

19. A non-transitory machine-readable medium, comprising executable instructions that, when executed by a processing system including a processor, facilitate performance of operations, the operations comprising:
monitoring a communications network to obtain metrics, wherein the monitoring comprises:
obtaining an image generated from parameters associated with operation of the communications network;
interpreting, utilizing a vision understander model, content of the image resulting in interpreted content information; and
translating the interpreted content information into content text that is part of the metrics;
analyzing the metrics by applying an Artificial Intelligence (AI) model resulting in an analysis; and
generating adjustment information for adjusting the communications network according to the analysis.

20. The non-transitory machine-readable medium of claim 19, wherein the adjustment information includes a prediction of a network condition determined by the analysis and includes a future time predicted for the network condition.
